(19) United States
(12) Patent Application Publication
(10) Pub. No.: US 2023/0005079 A1
(43) Pub. Date: Jan. 5, 2023

(54) SOCIAL INFORMATION PROCESSING METHOD AND APPARATUS, AND ELECTRONIC DEVICE

(71) Applicant: JOYME PTE. LTD., Singapore (SG)

(72) Inventor: Shan YANG, Singapore (SG)

(21) Appl. No.: 17/781,946

(22) PCT Filed: May 11, 2020
(86) PCT No.: PCT/CN2020/089588

§ 371 Date: Jun. 2, 2022

(30) Foreign Application Priority Data
Dec. 30, 2019 (CN) 201911396061.3

(51) Int. Cl. G06Q 50/00; H04L 51/52; G06F 3/0481

(52) U.S. Cl. CPC G06Q 50/01; H04L 51/52; G06F 3/0481

(57) ABSTRACT

A method for processing social information comprises: acquiring social information sent by an interactive object (101); determining whether a reply control is displayed according to the social information (102); if it is determined that the reply control is displayed, then displaying the social information and the reply control in a message list (103); and sending reply information to the interactive object in response to a user operation for the reply control (104).

### CROSS-REFERENCE TO RELATED APPLICATIONS

This application is a U.S. national phase entry of International Application No. PCT/CN2020/089588 filed on May 11, 2020, which claims priority to Chinese Patent Application No. 201911396061.3, filed on Dec. 30, 2019, the entire contents of which are incorporated herein by reference.

### TECHNICAL FIELD

The embodiments of the disclosure relate to the technical field of information processing, in particular to a method and an apparatus for processing social information and an electronic device.

### BACKGROUND

With the development of science and technology, people's social skills and means are increasingly rich and powerful, and people's social needs are becoming stronger and stronger. The number of people contacted through the Internet is very large. The current social means are also more abundant. Interactions are performed by live broadcasting or chatting, and interaction messages are displayed in a message list.

However, the current message list only displays messages, which may not meet people's growing interaction needs.

### SUMMARY

According to a first aspect of the disclosure, a method for processing social information includes: obtaining social information sent by an interaction object; determining whether a reply control is displayed based on the social information; in response to determining that the reply control is displayed, displaying the social information and the reply control in a message list; and in response to a user operation of the reply control, sending reply information to the interaction object.

According to a second aspect of the disclosure, an electronic device is provided. The electronic device includes: a processor, and a memory configured to store with a computer program executable by the processor. When the program is executed by the processor, the method for processing social information according to the first aspect is implemented.

According to a third aspect of the disclosure, a non-transitory computer-readable storage medium is provided, on which a computer program is stored. When the program is executed by a processor, the method for processing social information according to the first aspect is implemented.

Additional aspects and advantages of embodiments of the disclosure may be given in part in the following descriptions, become apparent in part from the following descriptions, or be learned from the practice of the embodiments of the disclosure.

### BRIEF DESCRIPTION OF THE DRAWINGS

The above and/or additional aspects and advantages of embodiments of the disclosure may become apparent and more readily appreciated from the following descriptions made with reference to the drawings, in which:

FIG. 1 is a schematic flowchart of a method for processing social information according to an embodiment of the present disclosure;

FIG. 2 is a schematic flowchart of another method for processing social information according to an embodiment of the present disclosure;

FIG. 3 is the 1^{st} schematic diagram of displaying a message list of social information according to the embodiment of the present disclosure;

FIG. 4 is the 2^{nd} schematic diagram of displaying a message list of social information according to the embodiment of the present disclosure;

FIG. 5 is the 3^{rd} schematic diagram of displaying a message list of social information according to the embodiment of the present disclosure;

FIG. 6 is a structural schematic diagram of an apparatus for processing social information according to an embodiment of the present disclosure; and

FIG. 7 is a structural schematic diagram of an electronic device according to an embodiment of the present disclosure.

### DETAILED DESCRIPTION

Embodiments of the disclosure may be described in detail, examples of which are illustrated in the drawings. The same or similar reference numerals throughout the specification refer to the same or similar elements or elements having the same or similar functions. Embodiments described herein with reference to drawings are explanatory, serve to explain the disclosure, and are not construed to limit embodiments of the disclosure.

The following describes a method and an apparatus for processing social information, and an electronic device according to the embodiments of the disclosure with reference to the accompanying drawings.

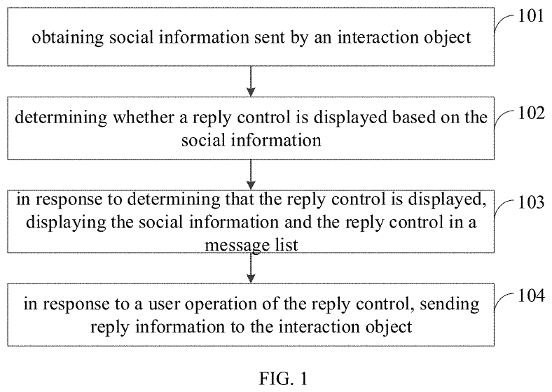

FIG. 1 is a schematic flowchart of a method for processing social information according to an embodiment of the disclosure. The method may be executed by an electronic device.

As shown in FIG. 1, the method includes the following steps.

At 101, social information sent by an interaction object is obtained.

The interaction object refers to a user who has interaction needs, such as fans and friends of an anchor, and the like. The content of the social information is different, and the type of the corresponding content is different. The social information may be specifically divided to be in a chat type and in a gift type. The chat type corresponds to a text message, for example. The gift type corresponds to a virtual gift rather than the text, for example.

At 102, it is determined whether a reply control is displayed based on the social information.

There is at least one reply control, which is generated based on historical reply information in response to giving a gift and/or set by default. The content of the reply control may be text, such as thank you, love you, or may be an expression, such as a smiling face, or may be a dynamic expression. As such, it achieves that the reply information is set based on habits and likes of the users.

In this embodiment, it is determined whether the reply control is displayed based on the type of the social information. In particular, when the content type of the social information is a gift type, it is determined the reply control is displayed. In other words, the interaction object sends a gift to a favorite object, such as a blogger or an anchor, a gift-based reply control needs to be displayed. When the content type of the social information is a chat type, it is determined the reply control does not need to be displayed. In other words, the interaction object sends a text message to the favorite object, the reply control does not need to be displayed and only a message list needs to displayed. As such, it achieves that the corresponding list is displayed based on different social information, thus improving the pertinence of information display, being convenient to remind users that they can reply as soon as possible when they get gifts, and improving the interaction.

At 103, in response to determining that the reply control is displayed, the social information and the reply control are displayed in a message list.

In this embodiment, the message list may be a message list in an application program, a message list in an applet or a message list on a web end, which is not limited in this embodiment.

Specifically, when the content type of the social information is the gift type, it is determined that the reply control is displayed, so as to display a thumbnail of the given gift and the reply control in the message list.

However, in practical applications, there may be more than one piece of social information sent by the interactive object obtained in the above steps, and the content types of social information may also be different. Therefore, the priority of different types of social information may be set and displayed in different ways in the message list based on the priority of different social information obtained.

Specifically, when it is determined the reply control is displayed, a display priority is determined based on the content type of social information. The display priority of the gift type is higher than that of the chat type. According to the display priority, the social information and reply control are displayed in the message list.

The following scenarios are used for specific description.

In a scenario, when the content type of the social message sent by the interaction object is obtained as a chat type first, only the interaction message in the chat type may be displayed in the message list. When the content type of another social message received is a gift type, the social message in the chat type may be hidden in the message list while the social message in the gift type and the corresponding reply control are displayed, since the display priority of the interaction message in the gift type is higher than that of the interaction message in the chat type.

In another scenario, when the content type of the social message sent by the interaction object is obtained as a gift type first, the social message in the gift type and the corresponding reply control are displayed in the message list. When the content type of another social message received is a chat type, displaying the social message in the gift type and the corresponding reply control are continued while the latest received social message in the chat type is not displayed in the message list, since the display priority of the interaction message in the gift type is higher than that of the interaction message in the chat type. Only social messages in the chat type are counted, and a total number of the social messages in the chat type is displayed in the message list. For example, one message is unread, or two messages are unread, etc., in order to facilitate the users to understand the number of unread social messages in the chat type, so that users may determine whether to view them, thus improving the flexibility.

In yet another scenario, when the content types of the social messages successively sent by the interaction object are obtained as gift types, only the latest received social message in the gift type and the corresponding reply control are displayed according to a time sequence of obtaining the social messages in the gift type, so as to realize a display of the latest social message.

Therefore, in this embodiment, the display priority is determined based on the content type of the social information, a priority display of social information in the gift type is ensured so that a quick reply may be made in response to obtaining a gift sent by an interaction user. Through the quick reply, the interactivity is increased, and interaction enthusiasm and positivity of the interactive user are improved.

At 104, in response to a user operation of the reply control, reply information is sent to the interaction object.

Specifically, the reply information is sent to the interaction object in response to the user operation of the reply control displayed. For example, the content corresponding to the replay control is the text “thanks” or a smiling face. When the user selects a replay control corresponding to the text “thanks”, the reply information sent to the interaction object is the text “thanks”.

In the method for processing social information according to the embodiment, the social information sent by the interaction object is obtained; it is determined whether the reply control is displayed based on the social information; in response to determining that the reply control is displayed, the social information and the reply control are displayed in the message list; and in response to the user operation of the reply control, the reply information is sent to the interaction object. By a special display of both the social information and the reply control in the message list, quick replies that meet the needs of users are provided, thus improving the timeliness of information interaction and increasing platform stickiness.

Based on the above embodiment, an embodiment of the disclosure provides a possible implementation of another method for processing social information.

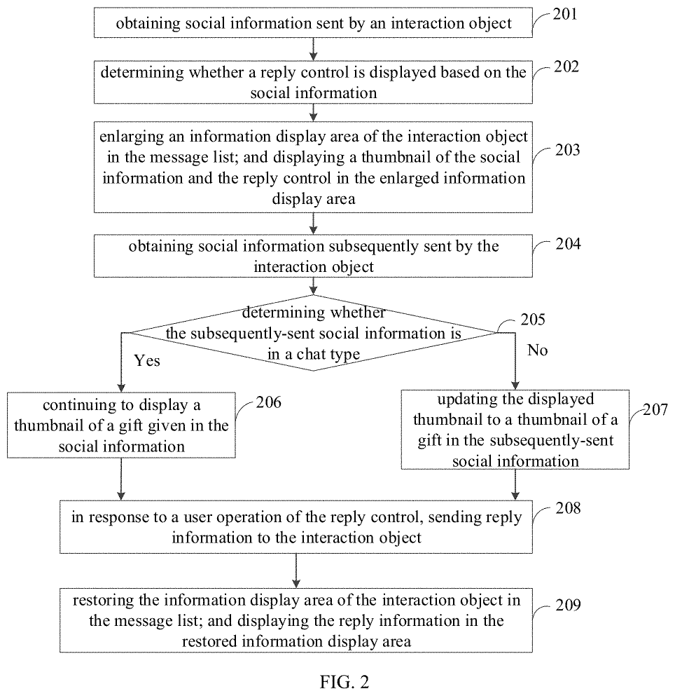

As shown in FIG. 2, the method includes the following steps.

At 201, social information sent by an interaction object is obtained.

In practical applications, there may be a plurality of social information sent by the interaction object obtained, and the type of social information may also be different. In this embodiment, the type of social information sent by the interaction object firstly obtained is a gift type.

At 202, it is determined whether a reply control is displayed based on the social information.

Specifically, the social information in the gift type needs to display a reply control. Therefore, according to the obtained social information as the social information in the gift type, it is determined that the social information in the gift type and the reply control are displayed in the message list.

At 203, in response to determining that the reply control is displayed, an information display area of the interaction object is enlarged in the message list, a thumbnail of the social information and the reply control are displayed in the enlarged information display area.

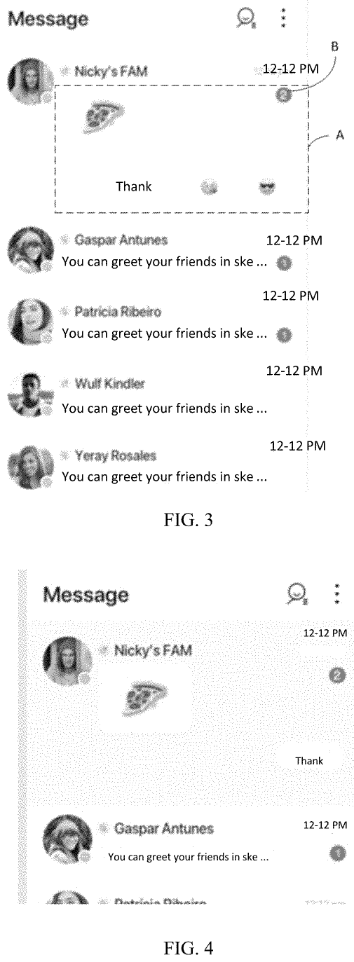

FIG. 3 is the 1^{st} schematic diagram of displaying a message list of social information according to the embodiment of the present disclosure. As shown in FIG. 3, the message list is a list of private messages between fans and the anchor in a live broadcasting application. The message list shows different interaction objects and social information sent by different interaction objects. The order of different users in the message list is usually arranged from top to bottom according to a time sequence of social information obtained. However, in this disclosure, since the priority of social information in the gift type is higher, the social message in the gift type sent by an interaction user and the corresponding interaction user are ranked higher. Therefore, the social information sent by the first user in the list (Nicky's FAM) is the latest social information obtained, and the type of social information is a gift type at the same time. Take this user as an example and this user is hereinafter referred to as the user N for ease of explanation. The social information sent by the user N is in the gift type, that is, the gift given by the user N is obtained as a pizza. In order to facilitate the display, an information display area of the interaction object is enlarged in the message list, such as the area A indicated by a dotted line in FIG. 3, and in the enlarged information display area, a thumbnail (i.e., a pizza) of the social information is displayed, and reply controls (i.e., a control whose reply content is “Thank” and two reply controls corresponding to different expressions) are displayed. By enlarging the display area, it is convenient to display the obtained gifts, so as to remind users to reply in time and improve the efficiency of interaction.

At 204, social information subsequently sent by the interaction object is obtained.

In practical applications, before the user selects the reply control, the interaction object may continue to send social information, and the content type of social information may be a gift type or a chat type.

At 205, it is judged whether the subsequently-sent social information is in a chat type. If so, the step at 206 is performed, if no, the step at 207 is performed.

At 206, displaying a thumbnail of the gift given in the social information is continued.

Specifically, it is judged whether the social information sent by the interaction object is in the chat type. If it is in the chat type, displaying the thumbnail of the gift given in the social information is continued when it is determined that the subsequently-sent social information is in a chat type, since the display priority of the social message in the chat type is lower than that of the social message in the gift type. As shown in FIG. 3, when the interaction object sends social information in the chat type again, displaying the gift pizza is continued in the enlarged information display area, i.e. the area indicated by A, and the reply control of the object is also displayed. However, in the information display area indicated by A, the number of social messages in the chat type is counted. That is, each time a chat type of social information is added, the cumulative count is increased by 1. In other words, the cumulative number (indicated by B in FIG. 3) of the obtained social messages in the chat type sent by the interaction object N is 2, meaning that the cumulative obtained social messages in the chat type sent by the interaction object N is 2, so as to remind the user of the chat information to be read. At the same time, the priority display of gift giving and reply information and the priority display of a thumbnail of the latest gift are carried out based on the priority of the set social information in the gift type and in the chat type, which improves the pertinence of information display, meets the interaction needs, and improves the efficiency of targeted information reply.

At 207, the displayed thumbnail is updated to a thumbnail of a gift in the subsequently-sent social information.

Specifically, when the social information subsequently sent by the interaction object is in a gift type, the displayed thumbnail is updated to the thumbnail of the gift in the subsequently-sent social information. In other words, when the interaction object N in FIG. 3 sends another social information which is still in a gift type, for example, the corresponding gift is a watermelon, the thumbnail of the gift (i.e., pizza) displayed in the information display area indicated by A in FIG. 3, is updated to the thumbnail of the latest received gift (i.e., watermelon), and the reply control is displayed accordingly. The reply controls corresponding to different gifts can be the same or different, which is not limited in this embodiment.

It should be noted that the given gift may correspond to an accumulated score or may be an actual gift having a corresponding value, etc., while different gifts may correspond to different accumulated scores or may be actual gifts of a corresponding value, which is not limited in this embodiment.

At 208, in response to a user operation of the reply control, reply information is sent to the interaction object.

As shown in FIG. 4, in response to a selection operation of the reply control corresponding to the reply content “Thank” by the user, the reply content “Thank” corresponding to the reply control is taken as the reply information and sent to the interaction object N. As such, it achieves that a quick reply to the information is made based on the gift given by the interaction object N, thus improving the interaction between users of receiving gifts and interaction users, and increasing the stickiness of users to the platform.

At 209, the information display area of the interaction object is restored in the message list, and the reply information is displayed in the restored information display area.

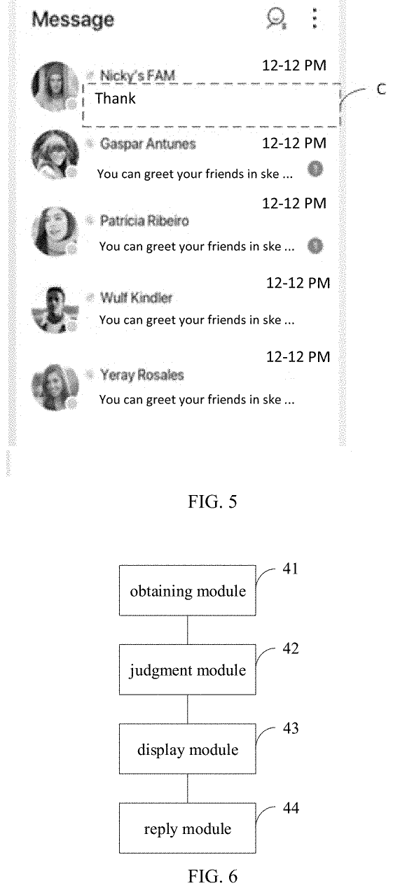

In this embodiment, in the message list, when the reply information is sent to the interaction object, the information display area of the interaction object is restored in the message list. In the message list of the interaction object N, the enlarged information display area indicated by A in FIG. 3 is restored to an initial information display area indicated by C in FIG. 5 in the message list, and the reply information (i.e., Thank) sent to the interaction user N is displayed in the restored information display area, so as to narrow down the content displayed in the message list for a whole view of the users.

It should be noted that the method for processing social information of other interaction users is the same as that of the above interaction user N, which may not be repeated here.

In the method for processing social information according to the embodiment, the social information sent by the interaction object is obtained; it is determined whether the reply control is displayed based on the social information; in response to determining that the reply control is displayed, the social information and the reply control are displayed in the message list; and in response to the user operation of the reply control, the reply information is sent to the interaction object. By a special display of both the social information and the reply control in the message list, quick replies that meet the needs of users are provided, thus improving the timeliness of information interaction and increasing platform stickiness. By setting the priority of social information in the message type and social information in the gift type, it may achieve that the priority display of the social information in the gift type, so that the user replies in time to the interaction user of giving a gift, thus increasing the interactivity.

In order to implement the above embodiments, the disclosure further provides an apparatus for processing social information.

FIG. 6 is a structural schematic diagram of an apparatus for processing social information according to an embodiment of the disclosure.

As shown in FIG. 6, the apparatus also includes an obtaining module 41, a judgment module 42, a display module 43 and a reply module 44.

The obtaining module 41 is configured to obtain social information sent by an interaction object.

The judgment module 42 is configured to determine whether a reply control is displayed based on the social information.

The display module 43 is configured to in response to determining that the reply control is displayed, display the social information and the reply control in a message list.

The reply module 44 is configured to in response to a user operation of the reply control, send reply information to the interaction object.

Further, in a possible implementation of the embodiment of the disclosure, the apparatus further includes: a display restoring module.

The display restoring module is configured to restore the information display area of the interaction object in the message list; and display the reply information in the restored information display area.

As a possible implementation, the display module 43 is further configured to: determine a display priority based on a content type of the social information; and display the social information and the reply control in the message list based on the display priority.

As a possible implementation, the content type includes a gift type and a chat type; and a display priority of the gift type is higher than a display priority of the chat type.

As a possible implementation, the judgment module 42 is further configured to: in response to a content type of the social information being a gift type, determining that the reply control is displayed; and in response to the content type of the social information being a chat type, determining that the reply control is not displayed.

As a possible implementation, there is at least one reply control and the at least one reply control is generated based on historical reply information in response to giving and/or set by default.

As a possible implementation, the display module 43 further includes: a display enlarging unit, configured to enlarge an information display area of the interaction object in the message list; and a thumbnail displaying unit, configured to display a thumbnail of the social information and the reply control in the enlarged information display area.

As a possible implementation, the thumbnail displaying unit is further configured to display a thumbnail of a gift given in the social information; and the obtaining module 41 is further configured to obtain social information subsequently sent by the interaction object; the display module 43 is further configured to in response to the subsequently-sent social information being in a chat type, continue to display the thumbnail; and in response to the subsequently-sent social information being in a gift type, update the displayed thumbnail to a thumbnail of a gift in the subsequently-sent social information.

It should be noted that the explanation of the method for processing social information in the above embodiment is also applicable to the apparatus for processing social information in the embodiment. The principle is the same, and may not be repeated here.

In the method for processing social information according to the embodiment, the social information sent by the interaction object is obtained; it is determined whether the reply control is displayed based on the social information; in response to determining that the reply control is displayed, the social information and the reply control are displayed in the message list; and in response to the user operation of the reply control, the reply information is sent to the interaction object. By a special display of both the social information and the reply control in the message list, quick replies that meet the needs of users are provided, thus improving the timeliness of information interaction and increasing platform stickiness. By setting the priority of social information in the message type and social information in the gift type, it may achieve that the priority display of the social information in the gift type, so that the user replies in time to the interaction user of giving a gift, thus increasing the interactivity.

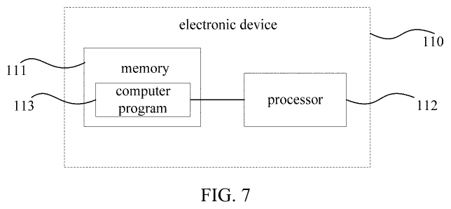

In order to implement the above embodiments, an embodiment of the disclosure provides an electronic device. FIG. 7 is a structural schematic diagram of the electronic device according to the embodiment of the disclosure. As shown in FIG. 7, the electronic device 110 includes a memory 111, a processor 112 and a computer program 113 that is stored in the memory 111 and may be executed on the processor 112. When the processor 112 executes the program 113, the method for processing social information described in the above method embodiments is implemented.

In order to implement the above embodiments, an embodiment of the disclosure provides a computer-readable storage medium on which a computer program is stored, and when the computer program is executed by a processor, the method for processing social information described in the above method embodiments is implemented.

In the description of this specification, description with reference to the terms “an embodiment,” “some embodiments,” “an example,” “a specific example,” or “some examples”, etc., mean a particular feature, structure, material, or characteristic described in connection with the embodiment or example is included in at least one embodiment or example of the disclosure. In this specification, schematic representations of the above terms are not necessarily directed to the same embodiment or example. Furthermore, the particular features, structures, materials or characteristics described may be combined in any suitable manner in any one or more embodiments or examples. In addition, different embodiments or examples and features of different embodiments or examples described in the specification may be combined by those skilled in the art without mutual contradiction.

In addition, the terms “first” and “second” are only used for purposes of description, and are not intended to indicate or imply relative importance or the number of indicated technical features. Thus, the feature defined with “first”, “second” may expressly or implicitly include at least one of that feature. In the description of the disclosure, “plurality” means at least two, such as two, three, etc., unless expressly and specifically defined otherwise.

Any process or method description in the flowcharts or otherwise described herein may be understood to represent a module, a segment or a portion of codes comprising one or more executable instructions for implementing specific logical functions or steps in the process, and the scope of a preferred embodiment of the disclosure includes alternative implementations in which the functions may be performed out of the order shown or discussed, including performing the functions in a substantially simultaneous manner or in the flipped order according to the functions involved, to perform the functions, which should be understood by those skilled in the art.

The logic and/or steps represented in flowcharts or otherwise described herein, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or N wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that various parts of this application may be implemented in hardware, software, firmware or their combination. In the above-described embodiments, various steps or methods may be implemented in software or firmware stored in memory and executed by a suitable instruction execution system. For example, if it is realized by the hardware, likewise in another embodiment, the steps or methods may be realized by one or a combination of the following techniques known in the art: discrete logic circuits having logic gate circuits for realizing a logic function of a data signal, an application-specific integrated circuit having an appropriate combination logic gate circuit, a programmable gate array (PGA), a field programmable gate array (FPGA), etc.

It may be understood by those skilled in the art that all or a part of the steps carried by the method in the above-described embodiments may be completed by relevant hardware instructed by a program. The program may be stored in a computer readable storage medium. When the program is executed, one or a combination of the steps of the method in the above-described embodiments may be completed.

In addition, individual functional units in the embodiments of the disclosure may be integrated in one processing module or may be separately physically present, or two or more units may be integrated in one module. The integrated module as described above may be achieved in the form of hardware, or may be achieved in the form of a software functional module. If the integrated module is achieved in the form of a software functional module and sold or used as a separate product, the integrated module may also be stored in a computer readable storage medium.

The above-mentioned storage medium may be a read-only memory, a magnetic disk or an optical disk, and the like. Although explanatory embodiments have been shown and described, it would be appreciated by those skilled in the art that the above embodiments cannot be construed to limit the disclosure, and changes, alternatives, and modifications may be made in the embodiments without departing from scope of the disclosure.

1. A method for processing social information, comprising:
obtaining social information sent by an interaction object;
determining whether a reply control is displayed based on the social information;
in response to determining that the reply control is displayed, displaying the social information and the reply control in a message list; and
in response to a user operation of the reply control, sending reply information to the interaction object.

2. The method of claim 1, wherein displaying the social information and the reply control in the message list comprises:
determining a display priority based on a content type of the social information; and
displaying the social information and the reply control in the message list based on the display priority.

3. The method of claim 2, wherein the content type comprises a gift type and a chat type; and
wherein a display priority of the gift type is higher than a display priority of the chat type.

4. The method of claim 1, wherein determining whether the reply control is displayed based on the social information comprises:
in response to a content type of the social information being a gift type, determining that the reply control is displayed; and
in response to the content type of the social information being a chat type, determining that the reply control is not displayed.

5. The method of claim 4, wherein there is at least one reply control for the social information from the interaction object and the at least one reply control is generated based on historical reply information in response to the interaction object giving gifts, and/or is set by default.

6. The method of claim 1, wherein displaying the social information and the reply control in the message list comprises:
enlarging an information display area of the interaction object in the message list; and
displaying a thumbnail of the social information and the reply control in the enlarged information display area.

7. The method of claim 6, wherein the method further comprises:
restoring the information display area of the interaction object in the message list; and
displaying the reply information in the restored information display area.

8. The method of claim 6, wherein displaying the thumbnail of the social information comprises:
displaying a thumbnail of a gift in the social information;
before in response to the user operation of the reply control, sending the reply information to the interaction object, the method further comprises:
obtaining social information subsequently sent by the interaction object;
in response to the subsequently-sent social information being in a chat type, displaying the thumbnail of the gift in the social information; and
in response to the subsequently-sent social information being in a gift type, updating the displayed thumbnail to a thumbnail of a gift in the subsequently-sent social information.

9. An electronic device, comprising:
a processor, and
a memory configured to store with a computer program executable by the processor, wherein the processor is configured to;
obtain social information sent by an interaction object;
determine whether a reply control is displayed based on the social information;
in response to determining that the reply control is displayed, display the social information and the reply control in a message list; and
in response to a user operation of the reply control, send reply information to the interaction object.

10. The electronic device of claim 9, wherein the processor is further configured to:
determine a display priority based on a content type of the social information; and
display the social information and the reply control in the message list based on the display priority.

11. The electronic device of claim 10, wherein the content type comprises a gift type and a chat type; and
wherein a display priority of the gift type is higher than a display priority of the chat type.

12. The electronic device of claim 9, wherein the processor is further configured to:
in response to a content type of the social information being a gift type, determining that the reply control is displayed; and
in response to the content type of the social information being a chat type, determining that the reply control is not displayed.

13. The electronic device of claim 12, wherein there is at least one reply control for the social information from the interaction object and the at least one reply control is generated based on historical reply information in response to the interaction object giving gifts, and/or is set by default.

14. The electronic device of claim 9, wherein the processor is further configured to:
enlarge an information display area of the interaction object in the message list; and
display a thumbnail of the social information and the reply control in the enlarged information display area.

15. The electronic device of claim 14, wherein the processor is further configured to:
restore the information display area of the interaction object in the message list; and display the reply information in the restored information display area.

16. The electronic device of claim 14, wherein the processor is further configured to:
display a thumbnail of a gift in the social information;
obtain social information subsequently sent by the interaction object;
in response to the subsequently-sent social information being in a chat type, display the thumbnail of the gift in the social information; and
in response to the subsequently-sent social information being in a gift type, update the displayed thumbnail to a thumbnail of a gift in the subsequently-sent social information.

17. (canceled)

18. A non-transitory computer-readable storage medium on which a computer program is stored, wherein when the program is executed by a processor, a method for processing social information, the method comprising:
obtaining social information sent by an interaction object;
determining whether a reply control is displayed based on the social information;
in response to determining that the reply control is displayed, displaying the social information and the reply control in a message list; and
in response to a user operation of the reply control, sending reply information to the interaction object.

19. The storage medium of claim 18, wherein displaying the social information and the reply control in the message list comprises:
determining a display priority based on a content type of the social information; and
displaying the social information and the reply control in the message list based on the display priority.

20. The storage medium of claim 19, wherein the content type comprises a gift type and a chat type; and
wherein a display priority of the gift type is higher than a display priority of the chat type.

21. The storage medium of claim 18, wherein determining whether the reply control is displayed based on the social information comprises:
in response to a content type of the social information being a gift type, determining that the reply control is displayed; and
in response to the content type of the social information being a chat type, determining that the reply control is not displayed.
